(19) United States
(12) Patent Application Publication
(10) Pub. No.: US 2017/0115445 A1
(43) Pub. Date: Apr. 27, 2017

(54) LIGHT GUIDE FILM AND MANUFACTURING METHOD THEREOF, LIGHT GUIDE PLATE AND MANUFACTURING AND RECYCLING METHODS THEREOF

(71) Applicants: BOE TECHNOLOGY GROUP CO., LTD., Beijing (CN); HEFEI BOE DISPLAY LIGHT CO., LTD., Hefei (CN)

(72) Inventor: Peina WANG, Beijing (CN)

(21) Appl. No.: 15/208,053

(22) Filed: Jul. 12, 2016

(30) Foreign Application Priority Data
Oct. 21, 2015 (CN) 201510695597.0

(51) Int. Cl. F21V 8/00

(52) U.S. Cl. CPC G02B 6/0041; G02B 6/0065

(57) ABSTRACT

A light guide film (LGF) and a manufacturing method thereof, a light guide plate (LGP) and manufacturing and recycling methods thereof are provided. The LGF includes a plurality of dots. The LGP includes a light guide substrate and the LGF, and the LGF is bonded to a surface of the light guide substrate.

### TECHNICAL FIELD

The present disclosure relates to a light guide film (LGF) and a manufacturing method thereof, a light guide plate (LGP) and manufacturing and recycling methods thereof.

### BACKGROUND

A display device generally includes a display panel and a backlight module. The backlight module includes a light source and an LGP. As illustrated in FIG. 1, in order to avoid the total reflection of light on an LGP 1, LGP dots 11 will be usually formed on the LGP 1. The LGP dots 11 are formed on a light-emitting side and/or a light incident side of the LGP 1 by injection molding, heat pressing or printing. Of course, the backlight module generally further includes a reflector and a diffusion layer (not illustrated in the figure). The reflector and the diffusion layer are combined with each other to form an integral structure. As the LGP dots 11 are formed on the LGP 1, in the process of optical redesign, the LGP 1 and the entire backlight module must be abandoned and reproduced, so the waste of materials can be caused and the cost can be increased.

### SUMMARY

An embodiment of the disclosure provides a light guide film (LGF), comprising a plurality of dots.

Another embodiment of the disclosure provides a method for manufacturing the above LGF, comprising: providing a film; and forming dots on a surface of the film.

Another embodiment of the disclosure provides a light guide plate (LGP), comprising: a light guide substrate and the above LGF, wherein the LGF is bonded to a surface of the light guide substrate.

Another embodiment of the disclosure provides a method for manufacturing the above LGP, comprising: providing the light guide substrate; and forming the LGF on the light guide substrate, wherein the LGF is combined with the light guide substrate by electrostatic adsorption, vacuum adsorption or adhesive bonding.

Another embodiment of the disclosure provides a backlight module, comprising: the above LGP and a light source, wherein the backlight module is a direct-lit backlight module or an edge-lit backlight module.

Another embodiment of the disclosure provides a method for recycling the above LGP, comprising: removing the LGF from the LGP.

Another embodiment of the disclosure provides a display device, comprising: a display panel and the above backlight module.

### BRIEF DESCRIPTION OF THE DRAWINGS

Simple description will be given below to the accompanying drawings of the embodiments to provide a more clear understanding of the technical proposals of the embodiments of the present invention. Obviously, the drawings described below only involve some embodiments of the present invention but are not intended to limit the present invention.

FIG. 1 is a schematic structural view of an LGP;

FIG. 2 is a top view of an LGF provided by the embodiment 1 of the present disclosure;

FIG. 3 is a schematic structural view of an LGF provided by the embodiment 2 of the present disclosure;

FIG. 4 is a schematic structural view of an LGP provided by the embodiment 4 of the present disclosure;

FIG. 5 is a schematic structural view of a backlight module provided by the embodiment 6 of the present disclosure; and

FIG. 6 is another schematic structural view of the backlight module provided by the embodiment 6 of the present disclosure.

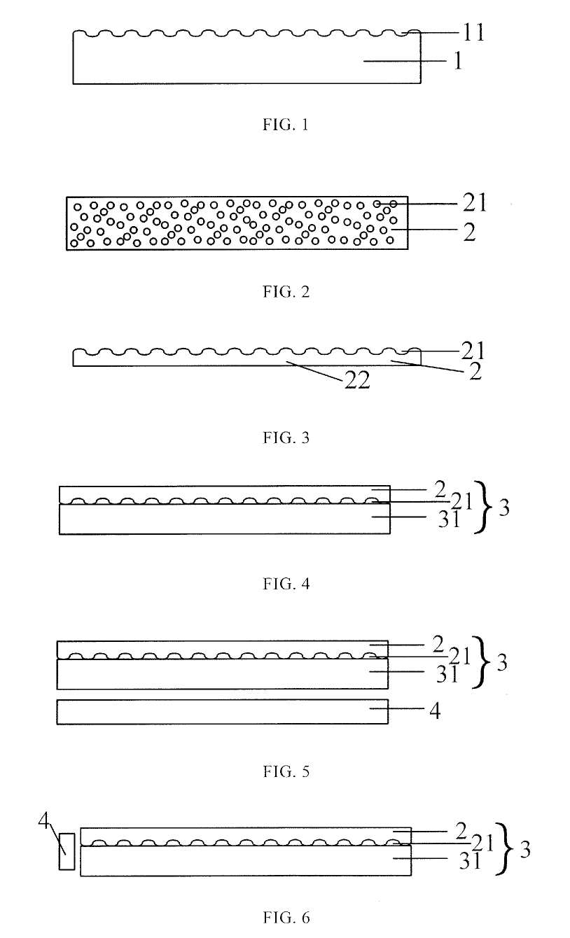

### DETAILED DESCRIPTION

For more clear understanding of the objectives, technical proposals and advantages of the embodiments of the present invention, clear and complete description will be given below to the technical proposals of the embodiments of the present invention with reference to the accompanying drawings of the embodiments of the present invention. Obviously, the preferred embodiments are only partial embodiments of the present invention but not all the embodiments. All the other embodiments obtained by those skilled in the art without creative efforts on the basis of the embodiments of the present invention illustrated shall fall within the scope of protection of the present invention.

### Embodiment 1

As illustrated in FIG. 2, the embodiment provides an LGF 2, which comprises a plurality of dots 21.

The LGF 2 provided by the embodiment comprises the plurality of dots 21. The dots 21 have the function of light diffusion, so that light can reach the far end, and meanwhile, also have the function of light refraction and reflection. As the LGF 2 is bonded to a surface of a light guide substrate, in the case of optical insufficiency and other issues, the user only needs to remove the LGF 2 and replaces a new LGF and does not need to replace the LGP and the entire backlight module, so that the cost can be saved. In addition, when a new machine is developed, the user only needs to bond the LGF 2 to the new machine and hence can confirm optical images at the very first time and does not require opening model, so that the development time can be saved. Moreover, the LGF 2 may be scrolled or folded.

### Embodiment 2

As illustrated in FIG. 3, the embodiment provides an LGF 2, which comprises a plurality of dots 21.

The height of each dot 21 is 6 to 15 μm. For instance, the height here refers to the distance between the bottom of a recessed portion between the dots and the top of the dot in the thickness direction of the LGF.

It should be understood that the height of the dot 21 is the depth of the recessed portion between the dots 21. In view of the dots 21, light emitted by a light source can be effectively refracted, reflected and diffused, so that the total reflection of the light on the LGF 2 can be avoided. Of course, the height of the dot 21 is not limited thereto and may also be other values, as long as the dot can have the function of light refraction, reflection and diffusion. No further description will be given here.

As illustrated in FIG. 3, the LGF 2 may comprise a base membrane 22, and the plurality of dots 21 may be distributed on a surface of the base membrane 22. For instance, the materials of the dots 21 and the base membrane 22 may be the same or different. In some examples, the dots 21 and the base membrane 22 are integrally formed.

The thickness of the LGF 2 is 10 to 80 μm.

It should be understood that the thickness of the LGF 2 includes the height of the dot 21. That is to say, the thickness of the LGF may be the sum of the thickness of the base membrane 22 and the height of the dot 21. The thickness of the LGF 2 is set to be 10-80 μm. When the LGF 2 is applied to a backlight module, the thickness of the backlight module can be effectively reduced, so that the backlight module can be light and thin.

The dots 21 are, for instance, made of resin or polyethylene terephthalate (PET).

For instance, the dot 21 may be semicircular, pyramidal or in other shapes.

In some examples, both the base membrane 22 and the dots 21 are made of transparent materials.

For instance, as the LGF 2 is a flexible film, the LGF can be scrolled or folded.

The LGF 2 provided by the embodiment comprises the plurality of dots 21. The dots 21 have the function of light diffusion, so that light can reach the far end, and meanwhile, also have the function of light refraction and reflection. As the LGF 2 is bonded to a surface of a light guide substrate 31, in the case of optical insufficiency and other issues, the user only needs to remove the LGF 2 and replaces a new LGF and does not need to replace the LGP and the entire backlight module, so that the cost can be saved. In addition, when a new machine is developed, the user only needs to bond the LGF 2 to the new machine and hence can confirm optical images at the very first time and does not require opening model, so that the development time can be saved. The LGF 2 may be scrolled or folded. Moreover, when the LGF 2 is applied to a backlight module, the thickness of the backlight module can be effectively reduced, so that the backlight module can be light and thin.

### Embodiment 3

The embodiment provides a method for preparing an LGF. The LGF is the LGF 2 provided by the embodiment 1 or 2. The manufacturing method comprises the following steps.

S101: providing a film; and

S102: forming dots 21 on a surface of the film.

For instance, the dots 21 are formed by printing, spraying, mechanical micromachining or chemical precipitation.

In the LGF prepared by the method for preparing the LGF, provided by the embodiment, the LGF 2 comprises the plurality of dots 21. The dots 21 have the function of light diffusion, so that light can reach the far end, and meanwhile, also have the function of light refraction and reflection. As the LGF 2 is bonded to a surface of a light guide substrate 31, in the case of optical insufficiency and other issues, the user only needs to remove the LGF 2 and replaces a new LGF and does not need to replace the LGP and the entire backlight module, so that the cost can be saved. In addition, when a new machine is developed, the user only needs to bond the LGF 2 to the new machine and hence can confirm optical images at the very first time and does not require mould opening, so that the development time can be saved. The LGF 2 may be scrolled or folded.

### Embodiment 4

As illustrated in FIG. 4, the embodiment provides an LGP. The LGP 3 comprises: a light guide substrate 31 and an LGF 2. The LGF 2 is the LGF 2 provided by the embodiment 1 or 2.

The position of the LGF 2 is not unique. For instance, the LGF 2 is disposed on the LGP 3, namely disposed on a light-emitting side of the LGP 3, or disposed beneath the LGP 3, namely disposed on a light incident side of the LGP 3, or disposed on and beneath the LGP 3, namely disposed on the light-emitting side and the light incident side of the LGP 3.

In addition, although as illustrated in FIG. 4, one side of the LGF 2 provided with the dots 21 is bonded to the light guide substrate 31, the LGP provided by the embodiment is not limited thereto. For instance, one side of the LGF 2 not provided with the dots 21 is bonded to the surface of the light guide substrate 31.

In the LGP 3 provided by the embodiment, the LGP 3 comprises the LGF 2, and the LGF 2 includes the plurality of dots 21. The dots 21 have the function of light diffusion, so that light can reach the far end, and meanwhile, also have the function of light refraction and reflection. As the LGF 2 is bonded to the surface of the light guide substrate 31, in the case of optical insufficiency and other issues, the user only needs to remove the LGF 2 and replaces a new LGF and does not need to replace the LGP 3 and the entire backlight module, so that the cost can be saved. In addition, when a new machine is developed, the user only needs to bond the LGF 2 to the new machine and hence can confirm optical images at the very first time and does not require opening model, so that the development time can be saved. The LGF 2 may be scrolled or folded.

### Embodiment 5

The embodiment provides a method for manufacturing an LGP. The LGP 3 is the LGP 3 provided by the embodiment 4. The manufacturing method comprises the following steps.

S201: providing a light guide substrate 31; and

S202: forming an LGF 2 on the light guide substrate 31.

For instance, the LGF 2 is combined with the light guide substrate 31 by electrostatic adsorption, vacuum adsorption or adhesive bonding.

The reason of combining the LGF 2 with the LGP 3 by electrostatic adsorption, vacuum adsorption or adhesive bonding is that: the combination of both by the above means does not need to adopt other structures for fixing, so that the problem of inaccurate combined position or displacement can be avoided.

In the LGP manufactured by the method for manufacturing the LGP, provided by the embodiment, the LGP 3 comprises the LGF 2, and the LGF 2 includes a plurality of dots 21. The dots 21 have the function of light diffusion, so that light can reach the far end, and meanwhile, also have the function of light refraction and reflection. As the LGF 2 is bonded to a surface of the light guide substrate 31, in the case of optical insufficiency and other issues, the user only needs to remove the LGF 2 and replaces a new LGF and does not need to replace the LGP and the entire backlight module, so that the cost can be saved. In addition, when a new machine is developed, the user only needs to bond the LGF 2 to the new machine and hence can confirm optical images at the very first time and does not require mould opening, so that the development time can be saved. The LGF 2 may be scrolled or folded.

### Embodiment 6

The embodiment provides a backlight module, which comprises: an LGP and a light source 4. The LGP 3 is the LGP provided by the embodiment 4, and the light source 4 is an edge-lit light source or a direct-lit light source. That is to say, the backlight module is an edge-lit backlight module or a direct-lit backlight module.

As illustrated in FIG. 5, the light source 4 is disposed below the LGP. Or as illustrated in FIG. 6, the light source 4 is disposed on one side of the LGP, namely arranged horizontally with the LGP. The display principle of this case is similar to the display principle of the case that the light source 4 is disposed below the LGP. No further description will be given here.

The backlight module provided by the embodiment comprises the LGP which includes an LGF 2, and the LGF 2 includes a plurality of dots 21. The dots 21 have the function of light diffusion, so that light can reach the far end, and meanwhile, also have the function of light refraction and reflection. As the LGF 2 is bonded to a surface of a light guide substrate 31, in the case of optical insufficiency and other issues, the user only needs to remove the LGF 2 and replaces a new LGF and does not need to replace the LGP 3 and the entire backlight module, so that the cost can be saved. In addition, when a new machine is developed, the user only needs to bond the LGF 2 to the new machine and hence can confirm optical images at the very first time and does not require opening model, so that the development time can be saved. The LGF 2 may be scrolled or folded.

### Embodiment 7

The embodiment provides a method for recycling a backlight module. The backlight module is the backlight module provided by the embodiment 6. The recycling method comprises removing the LGF 2 from the LGP 3.

In the method for recycling the backlight module, provided by the embodiment, the backlight module includes the LGF 2. As the LGF 2 is bonded to a surface of a light guide substrate 31, in the case of optical insufficiency and other issues, the user only needs to remove the LGF 2 and replaces a new LGF and does not need to replace the LGP 3 and the entire backlight module, so that the cost can be saved.

### Embodiment 8

The embodiment provides a display device, which comprises a display panel and a backlight module. The backlight module is the backlight module provided by the embodiment 6. For instance, the display panel may be a liquid crystal display (LCD) panel or other display panels comprising the backlight module.

The display device may be: any product or component with display function such as e-paper, a mobile phone, a tablet PC, a TV, a display, a notebook computer, a digital picture frame and a navigator.

The display device provided by the embodiment comprises the backlight module which includes an LGF, and the LGF 2 includes a plurality of dots 21. The dots 21 have the function of light diffusion, so that light can reach the far end, and meanwhile, also have the function of light refraction and reflection. As the LGF 2 is bonded to a surface of a light guide substrate 31, in the case of optical insufficiency and other issues, the user only needs to remove the LGF 2 and replaces a new LGF and does not need to replace the LGP 3 and the entire backlight module, so that the cost can be saved. In addition, when a new machine is developed, the user only needs to bond the LGF 2 to the new machine and hence can confirm optical images at the very first time and does not require mould opening, so that the development time can be saved. The LGF 2 may be scrolled or folded.

The foregoing is only the preferred embodiments of the present invention and not intended to limit the scope of protection of the present invention. The scope of protection of the present invention should be defined by the appended claims.

The application claims priority to the Chinese patent application No. 201510695597.0, filed on Oct. 21, 2015, the disclosure of which is incorporated herein by reference as part of the application.

1. A light guide film (LGF), comprising a plurality of dots.

2. The LGF according to claim 1, wherein the height of each dot is 6 to 15 μm.

3. The LGF according to claim 1, wherein the thickness of the LGF is 10 to 80 μm.

4. The LGF according to claim 1, wherein the LGF is a flexible film.

5. The LGF according to claim 1, wherein the dot is made of resin or polyethylene terephthalate (PET).

6. The LGF according to claim 1, further comprising a base membrane, wherein the plurality of dots are distributed on the base membrane.

7. The LGF according to claim 6, wherein the base membrane and the plurality of dots are integrally formed.

8. A method for manufacturing the LGF according to claim 1, comprising:
providing a film; and
forming dots on a surface of the film.

9. The method for preparing the LGF according to claim 8, wherein the dots are formed by printing, spraying, mechanical micromachining or chemical precipitation.

10. A light guide plate (LGP), comprising: a light guide substrate and the LGF according to claim 1, wherein the LGF is bonded to a surface of the light guide substrate.

11. A method for manufacturing the LGP according to claim 10, comprising:
providing the light guide substrate; and
forming the LGF on the light guide substrate, wherein
the LGF is combined with the light guide substrate by electrostatic adsorption, vacuum adsorption or adhesive bonding.

12. A backlight module, comprising: the LGP according to claim 10 and a light source, wherein the backlight module is a direct-lit backlight module or an edge-lit backlight module.

13. A method for recycling the LGP according to claim 10, comprising:
removing the LGF from the LGP.

14. A display device, comprising: a display panel and the backlight module according to claim 12.
